(19) United States
(12) Patent Application Publication
(10) Pub. No.: US 2025/0376056 A1
(43) Pub. Date: Dec. 11, 2025

(54) CABLE MANAGEMENT SYSTEM FOR AN ENERGY TRANSFER SYSTEM

(71) Applicant: Caterpillar Inc., Peoria, IL (US)

(72) Inventors: Matthew SHERWOOD, Christchurch (NZ); Richard JAMES, Christchurch (NZ)

(73) Assignee: Caterpillar Inc., Peoria, IL (US)

(21) Appl. No.: 18/736,064

(22) Filed: Jun. 6, 2024

(51) Int. Cl. B60L 53/18

(52) U.S. Cl. CPC B60L 53/18; B60L 2200/40

(57) ABSTRACT

In some implementations, an energy transfer system includes a housing. The energy transfer system includes a robotic system movable between an interior of the housing and an external environment. The energy transfer system includes one or more energy transfer cables coupled to the robotic system for enabling energy transfer. The energy transfer system includes a cable management system configured within the interior of the housing, the cable management system comprising one or more cable holder components movably configured on a slide apparatus, and the one or more energy transfer cables are configured to be routed through respective cable holder components of the one or more cable holder components.

### TECHNICAL FIELD

The present disclosure relates generally to an energy transfer system and, for example, to a cable management system for an energy transfer system.

### BACKGROUND

Machines (e.g., that utilize a type of energy source other than fossil fuel, such as electricity, hydrogen, methanol, ammonia, or other sources of energy other than a fossil fuel), such as vehicles or other mobile machines, that are at least partially powered by on-board energy storage systems (e.g., batteries, hydrogen fuel cells, chemical storage components, among other examples) can be environmentally-friendly alternatives to machines powered by fossil fuels. However, in many cases, when a machine operates throughout the day, the on-board energy storage system needs to be replenished several times over the course of the day (e.g., at least five (5) times per day) to ensure that the machine has enough power to continuously operate. In some cases, a technician can connect one or more energy replenishing connectors to one or more receptacles of the machine (e.g., that are associated with an on-board energy storage system of the machine) to allow for the on-board energy storage system of the machine to be replenished. However, this manual process is subject to error (e.g., where a connector is not accurately inserted into a receptacle). This can result in a sub-optimal replenishment of the on-board energy storage system for the machine, such as in terms of an increased amount of time needed to replenish the energy for the machine and a decreased available energy level on-board the machine. Sub-optimal replenishment can impact operations of a machine, such as by reducing an amount of time that the machine is available to perform powered operations (e.g., as compared to an amount of time that the machine needs to be replenished with energy) and by reducing an amount of power that is available to perform the powered operations. Sub-optimal replenishment of the on-board energy storage system for the machine can, in some cases, also degrade the on-board energy storage system of the machine, which impacts a performance and/or an operable life of the on-board energy storage system, and of the machine.

In some examples, energy transfer between an energy transfer dispenser system and a machine may be accomplished using one or more energy transfer cables. An energy transfer cable may be a medium for transferring energy between the energy transfer dispenser system and a receptacle on the machine. However, some energy transfer cables have a large size and limited flexibility. For example, energy transfer cables designed for high-energy transfers may be bulky and rigid, resulting in the energy transfer cables being difficult to maneuver and/or bend. Maneuvering the energy transfer cables in tight spaces and/or through complex setups or systems is cumbersome and presents logistical and/or system design challenges. This increases the risk of damage to the energy transfer cables caused by bending the energy transfer cables to a radius that is less than a bend radius of the energy transfer cables. Additionally, system for energy transfer may have many components and/or moving parts. This increases the risk of damage to the energy transfer cables, the components, and/or moving parts caused by the energy transfer cables contacting, rubbing, moving, and/or otherwise engaging with the components and/or moving parts as the system operates. Further, because of the large size and limited flexibility of the energy transfer cables, it is difficult to maintain a desired tension level in the energy transfer cables as the system operates. Failing to maintain the desired tension level may result in slack in the energy transfer cables (e.g., increasing the risk of the energy transfer cables contacting or being caught on other components of the system) and/or resulting in excessive tension in the energy transfer cables (e.g., increasing the risk of damage to the energy transfer cables caused by the excessive tension).

Korea Patent No. 102207226 (“the '226 patent”) discloses an electric vehicle charging device equipped with a charging cable adjustment means. The '226 patent discloses that by lifting or lowering a charging cable with force, not only can the position of the charging gun of the charging cable and the charging port of the electric vehicle be accurately aligned. The '226 patent discloses a rail guide connected to the charging body; a traveling body for transporting the charging cable while traveling on the rail guide; and a cable raising and lowering control means mounted on the traveling body to be able to raise and lower the cable to move and adjust the charging cable in an upward and downward direction.

While the '226 patent discloses a charging cable adjustment means, the '226 patent does not disclose any mechanisms for routing cables in tight spaces and/or through complex setups or systems while ensuring that the cables do not bend beyond the bend radius of the cables. Additionally, the '226 patent does not disclose any mechanisms for maintaining tension in the cables as the system operates.

The energy transfer system and/or the cable management system of the present disclosure solves one or more of the problems set forth above and/or other problems in the art.

### SUMMARY

An energy transfer system may include a housing; a robotic system movable between an interior of the housing and an external environment; one or more energy transfer cables coupled to the robotic system for enabling energy transfer; and a cable management system configured within the interior of the housing, the cable management system comprising one or more cable holder components movably configured on a slide apparatus, and the one or more energy transfer cables are configured to be routed through respective cable holder components of the one or more cable holder components.

A cable management system for energy transfer cables may include a base structure; one or more slide rails mechanically coupled to the base structure; and one or more cable holder components pivotably coupled to respective slide rails of the one or more slide rails, the one or more cable holder components being movable along the one or more slide rails, and the one or more cable holder components having a curved shape to prevent bending of the energy transfer cables beyond a bend radius of the energy transfer cables.

A system may include a housing; a robotic system movable between an interior of the housing and an external environment; one or more energy transfer cables coupled to the robotic system for enabling energy transfer; and a cable management system configured within the interior of the housing, the cable management system comprising: a base structure; a slide apparatus supported by the base structure; and one or more cable holder components movably configured on the slide apparatus, wherein the one or more energy transfer cables are routed to the robotic system through respective cable holder components of the one or more cable holder components.

### BRIEF DESCRIPTION OF THE DRAWINGS

FIG. 1 is a diagram of an example work machine described herein.

FIGS. 2A-2B are diagrams of an example energy transfer system.

FIG. 3 is a diagram of an example of the energy transfer system.

FIG. 4 is a diagram of an example of the cable management system described herein.

FIG. 5 is a diagram of an example of a cable holder component of the cable management system described herein.

FIG. 6 is a diagram of an example of the cable management system described herein.

FIG. 7 is a diagram of an example of an cable holder component of the cable management system described herein.

### DETAILED DESCRIPTION

This disclosure relates to an energy transfer system that is configured to enable an energy transfer to a work machine, which is applicable to any work machine that is at least partially powered by a non-fossil-fuel-based energy storage system (e.g., energy other than fossil-fuel-based energy), such as a battery system. The work machine may be any type of machine configured to perform operations associated with an industry such as mining, construction, farming, transportation, or any other industry. Although some examples are described herein in associated with electrical energy transfer, the techniques, implementations, systems, devices, and/or components described herein may be similarly applicable for other types of energy transfer, such as hydrogen transfer, biofuel transfer, and/or gas transfer (e.g., propane, liquefied petroleum gas, compressed natural gas, liquefied natural gas, or other types of gas), among other examples.

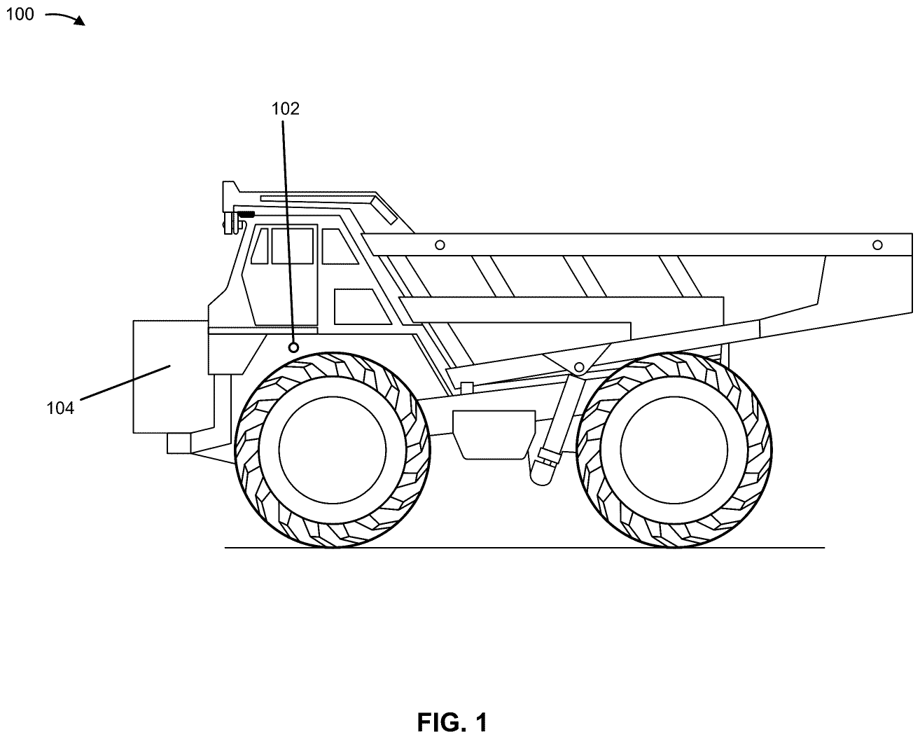

FIG. 1 is a diagram (e.g., a side-view) of an example work machine 100 described herein. The work machine 100 may be a mobile machine or vehicle, and may include a dump truck, a wheel loader, a hydraulic excavator, or another type of machine. Further, the work machine 100 may be a manned machine or an unmanned machine. The work machine 100 may be fully-autonomous, semi-autonomous, or remotely operated. As further shown in FIG. 1, the work machine 100 may include an energy storage system 102 (e.g., included within a chassis of the work machine 100) and a receptacle access point 104.

The work machine 100 may be configured to be at least partially powered by the energy storage system 102. That is, the work machine 100 may be a machine that utilizes electricity, hydrogen, methanol, ammonia, and/or other sources of energy other than a fossil fuel. As an example, the energy storage system 102 may include one or more batteries that store energy to be used to power one or more components of the work machine 100. For example, the work machine 100 may be a battery electric machine (BEM), a battery electric vehicle (BEV), a hybrid vehicle, a fuel cell and battery hybrid vehicle, or another machine that is at least partially powered by the energy storage system 102. The work machine 100 may include one or more electric engines, one or more electric motors, one or more electrical conversion systems, and/or other electrical components that are configured to convert and/or use energy, such as energy stored in the energy storage system 102, to cause overall movement of the work machine 100 across a work site and/or to cause movement of individual components or systems of the work machine 100.

The receptacle access point 104 provides an energy transfer interface (e.g., a wired energy transfer interface) for the energy storage system 102 and/or another fuel or energy storage of the work machine 100. For example, the receptacle access point 104 provides an energy transfer interface that can be physically connected to an energy transfer system (e.g., the energy transfer system 200 described herein) to allow an energy transfer from the energy transfer system to the energy storage system 102 (or vice versa) or other fuel or energy storage.

As indicated above, FIG. 1 is provided as an example. Other examples may differ from what is described in connection with FIG. 1.

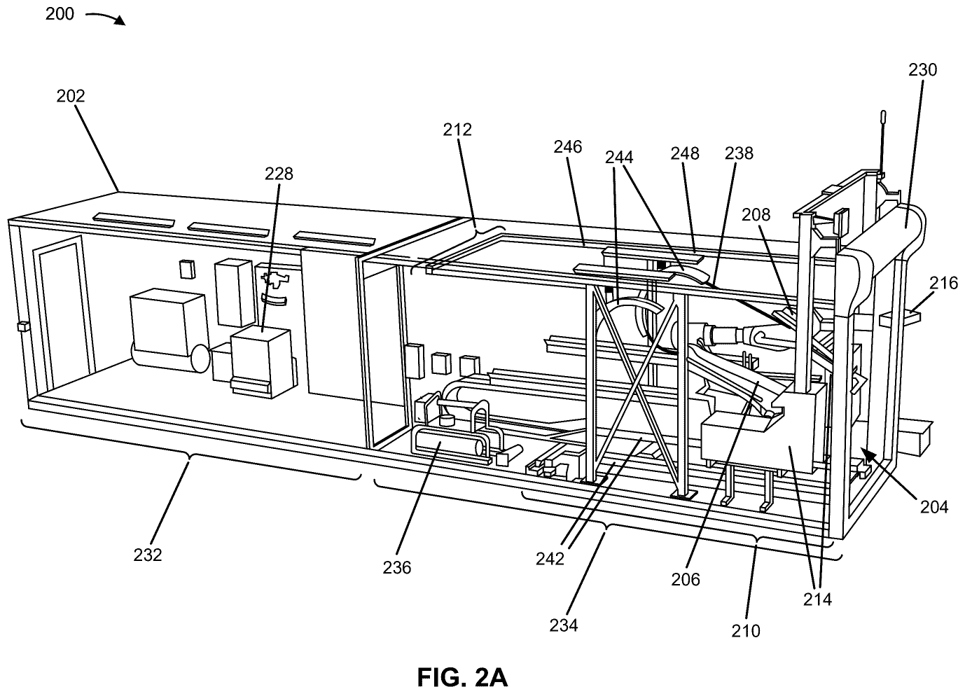

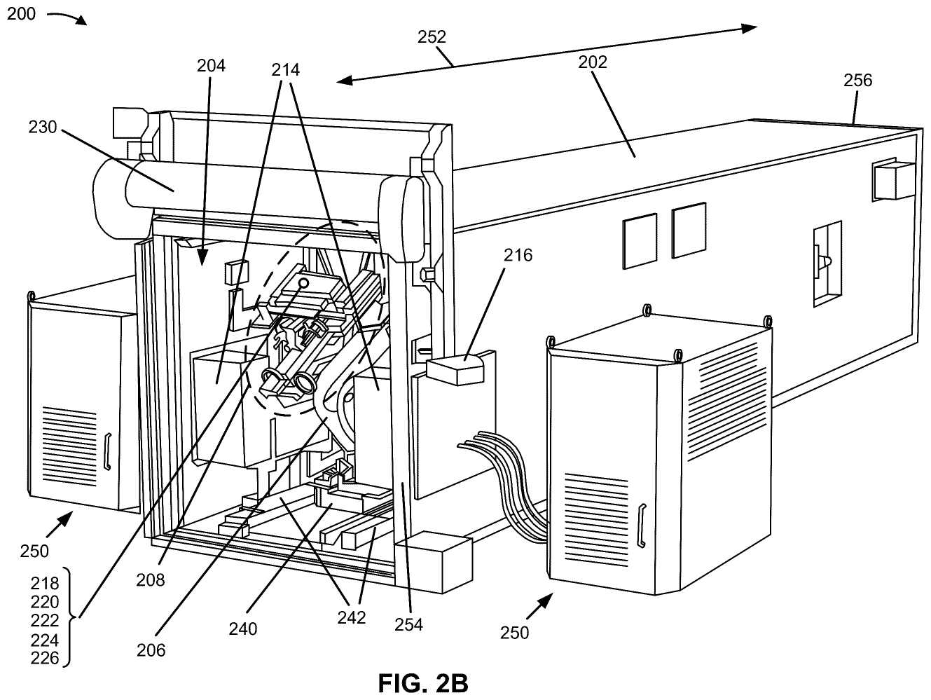

FIGS. 2A-2B are diagrams of an example energy transfer system 200. The energy transfer system 200 is configured to enable an energy transfer to and/or from the work machine 100 (e.g., to and/or from the energy storage system 102 of the work machine 100). In some implementations, the energy transfer system 200 is configured to autonomously enable the energy transfer (e.g., as further described herein), such as without any interaction with a human technician. However, other implementations include a human technician interacting with the energy transfer system 200 and, thus, the term “energy transfer system” includes any energy transfer system that is at least semi-autonomous (e.g., includes at least one autonomously controlled or operated system or component). FIG. 2A shows a side (cut-away) view of the energy transfer system 200, and FIG. 2B shows a front-angled view of the energy transfer system 200.

As shown in FIGS. 2A-2B, the energy transfer system 200 may include a housing 202 that includes a portal 204 at an end of the housing; a robotic system 206 that includes an end effector 208; a slide system 210; a cable management system 212; an energy transfer outlet system 214; a first camera system 216; a second camera system 218; a door opening system 220; a connector retention system 222; a connector protection system 224; a door closing system 226; and/or one or more controllers 228.

The housing 202 includes a metal, or other hard and/or weather resistant material, and may have a rectangular prism shape and/or other shapes. The housing 202 may include the portal 204 at an end of the housing 202 (e.g., instead of one of the short sides of the housing 202). The energy transfer system 200 may include a housing door 230 that is configured to cover the portal 204 when closed, and to uncover the portal 204 when open. For example, the housing door 230 may be a retractable door. The housing door 230, when closed, may protect an interior of the housing 202, such by preventing dirt, rocks, construction debris, waste matter, moisture, or other material (e.g., present at a work site at which the work machine 100 is operating) from accessing interior of the housing 202.

As shown in FIG. 2A, the interior of the housing 202 may be divided into a first interior portion 232 of the housing 202 and a second interior portion 234 of the housing 202 (e.g., that is separated by a wall, a door, or another separator). The first interior portion 232 of the housing 202 may include the one or more controllers 228 and/or one or more other electrical components, one or more pneumatic components, and/or one or more other communication components, among other examples, that enable operation of the systems and components included in the second interior portion 234 of the housing 202.

The second interior portion 234 of the housing 202 may include the slide system 210, the cable management system 212, and the energy transfer outlet system 214. The second interior portion 234 may also include additional systems and/or components for enabling operation of the robotic system 206 and/or an energy transfer operation, such as a pressure washer system 236 and one or more energy transfer cables 238 (e.g., that are configured to transmit energy to and/or from one or more plugs of the end effector 208). As shown in FIG. 2A, the second interior portion 234 may be associated with the end of the housing 202 that includes the portal 204. The slide system 210 is configured to move the robotic system 206, via the portal 204 of the housing 202, between an interior of the housing 202 (e.g., the second interior portion 234 of the housing 202) and an external environment (e.g., that surrounds the housing 202, such as at a work site). The slide system 210 may include a mount 240 for connecting to the robotic system 206 (e.g., for holding the robotic system 206 as the robotic system is moved by the slide system 210) and a slide apparatus 242 for moving the robotic system 206.

The cable management system 212 is configured to provide management of the one or more energy transfer cables 238. For example, as shown in FIG. 2A, the cable management system 212 may include one or more cable holder components 244 that prevent bending of the one or more energy transfer cables 238 (e.g., beyond a bend radius of the one or more energy transfer cables 238). The bend radius may be a permitted or permissible (a minimum) radius an energy transfer cable 238 can be bent without risking damage to the integrity or performance of the energy transfer cable 238. The cable management system 212 may include one or more slide apparatuses 246 that are configured to move the one or more cable holder components 244. For example, the one or more slide apparatuses 246 may move the one or more cable holder components 244 in association with (e.g., in tandem with) with movement of the robotic system 206 by the slide system 210 (e.g., to prevent a likelihood of damage to the one or more energy transfer cables 238 due to movement of the robotic system 206). The one or more cable holder components 244 are configured to move or slide along respective rails 248 included in the one or more slide apparatuses 246. For example, the one or more cable holder components 244 can slide along a length 252 of the housing 202 (e.g., where the length 252 extends from a first end 254 (e.g., a front side of the housing 202) of the housing 202 (e.g., that includes the portal 204) to a second end 256 of the housing 202). The slide apparatus 246 enables the one or more cable holder components 244 to move along a plane that is perpendicular to the front side of the housing 202 (e.g., a plane perpendicular to the first end 254). The length 252 is shown in FIG. 2B.

As shown in FIGS. 2A-2B, the first camera system 216 may be mounted on an exterior (e.g., an exterior side) of the housing 202. The first camera system 216 may include one or more cameras or other image capturing devices. The second camera system 218 is configured to obtain second image data associated with the access mechanism of the receptacle access point 104 and/or of one or more receptacles of the work machine 100. The door opening system 220 is configured to open an access door of the receptacle access point 104 (e.g., based on the location of an access mechanism of the receptacle access point 104 identified by the one or more controllers 228). The door opening system 220 may include a manipulation system for manipulating the access mechanism of the receptacle access point 104 to allow the access door to open.

The energy transfer outlet system 214 is a dispenser system for one or more energy transfer cables 238 coupled to the end effector 208. The energy transfer outlet system 214 is mounted or configured in the interior of the housing 202. The energy transfer outlet system 214 is configured for enabling connection between the one or more energy transfer cables 238 and an external energy transfer dispenser system 250 (e.g., that is not included in the energy transfer system 200). The energy transfer dispenser system 250 may be, for example, configured as a high-capacity external transfer dispenser system that transmits and distributes electrical power at a scale of millions of watts (megawatts) (e.g., the energy transfer dispenser system 250 may include one or more megawatt dispensers). In other examples, the energy transfer dispenser system 250 may be another type of energy transfer dispenser system, such as a hydrogen fuel dispenser, and/or a biofuel dispenser, among other examples. Accordingly, the energy transfer dispenser system 250 may provide energy to the one or more energy transfer cables 238, and thus to plugs of the end effector 208 via the energy transfer outlet system 214.

As indicated above, FIGS. 2A-2B are provided as an example. Other examples may differ from what is described in connection with FIGS. 2A-2B.

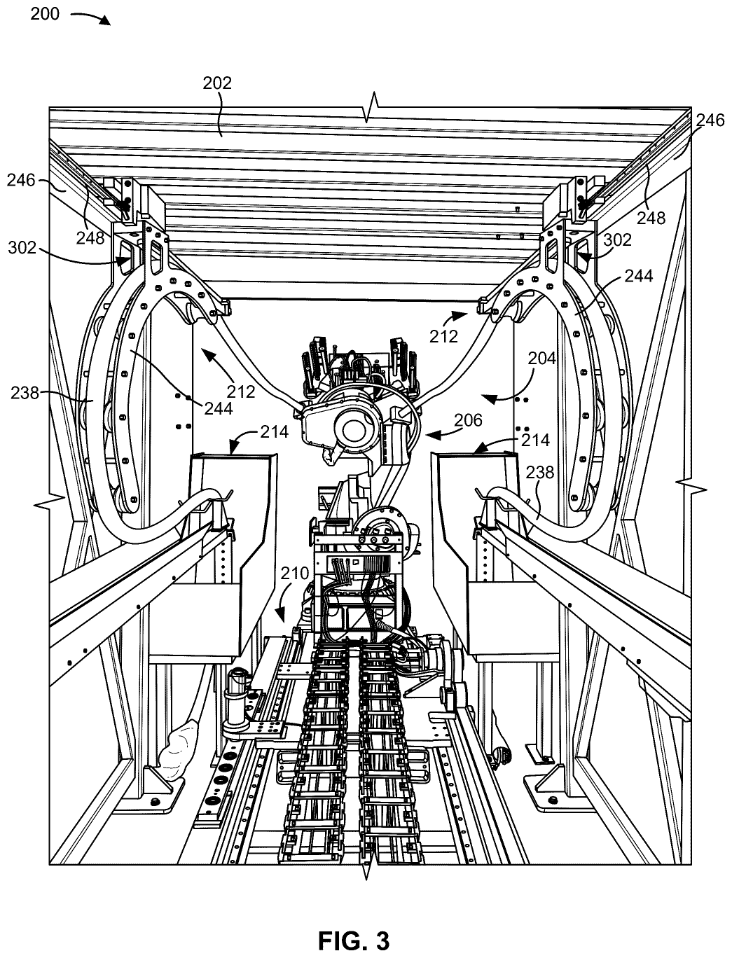

FIG. 3 is a diagram of an example of the energy transfer system 200. The view shown in FIG. 3 is from the interior of the housing 202, such as from behind the robotic system 206 looking out through the portal 204.

As shown in FIG. 3, an energy transfer cable 238 is output from the energy transfer outlet system 214. For example, the energy transfer cable 238 extends from an outlet of the energy transfer outlet system 214. The energy transfer cable 238 is routed to the end effector 208 of the robotic system 206 via the cable management system 212. For example, the energy transfer cable 238 is routed over a cable holder component 244. For example, the energy transfer cable(s) of the energy transfer system 200 are configured to be routed through respective cable holder components 244. As shown in FIG. 3, the energy transfer cable 238 may be routed from below the cable holder component 244 to over the top of the cable holder component 244 (e.g., through an opening 302 between a top of the cable holder component 244 and a bottom of a rail 248).

The cable holder component 244 may move (e.g., slide) along the slide apparatus 246 (e.g., via a rail 248) as the robotic system 206 (e.g., via the slide system 210) and/or the end effector 208 move. The reduces the complexity associated with routing the energy transfer cable 238 for the energy transfer system 200, reduces the length of the energy transfer cable 238, and/or reduces the likelihood of damage to the energy transfer cable 238 that may otherwise be caused by the energy transfer cable 238 being bent at a radius that is less than a bend radius of the energy transfer cable 238, among other examples. For example, as shown in FIG. 3, the cable holder component 244 has a curved shape or configuration defined by a radius. The radius of the cable holder component 244 is based on the bend radius of the energy transfer cable 238. For example, the radius is greater than or equal to the bend radius of the energy transfer cable 238. This reduces the likelihood that the energy transfer cable 238 is bent at a radius that is less than the bend radius (e.g., reducing the likelihood of damage to the energy transfer cable 238 that would otherwise be caused by the energy transfer cable 238 being bent at a radius that is less than the bend radius).

As indicated above, FIG. 3 is provided as an example. Other examples may differ from what is described in connection with FIG. 3.

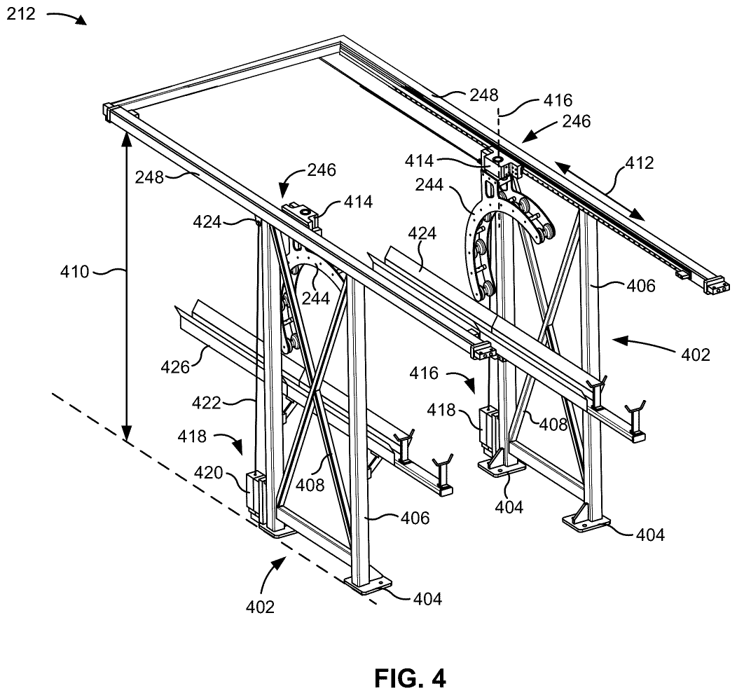

FIG. 4 is a diagram of an example of the cable management system 212 described herein.

The cable management system 212 includes a base structure 402. The base structure includes one or more members configured to support the cable management system 212. The base structure 402 is mounted to, configured to, and/or otherwise engaged with the housing 202 (not shown in FIG. 4). For example, the base structure 402 includes one or more mounting plates 404 configured for mounting, configuring, and/or otherwise engaging the base structure 402 with the housing 202 (e.g., with a floor of the housing 202, as shown in FIG. 2A). The base structure 402 is connected or engaged with the housing 202 via one or more mechanical connections or couplings (e.g., bolts, screws, or other mechanical means), a welded connection, or another connection.

The base structure 402 includes one or more vertical members 406 and one or more cross members 408. The vertical members 406 extend vertically from respective mounting plates 404. The one or more cross members 408 extend between two or more vertical members 406 (e.g., to structurally support the two or more vertical members 406).

The cable management system 212 includes the slide apparatus 246 supported by the base structure 402. The slide apparatus 246 is configured on the base structure 402 at a height 410 that is based on a connection point at which the one or more energy transfer cables 238 are connected to the robotic system 206 (e.g., as shown in FIG. 3). For example, the slide apparatus 246 is configured at the height 410 that is higher than or equal to the connection point at which the one or more energy transfer cables 238 are connected to the robotic system 206 (e.g., to facilitate the energy transfer cables 238 being routed to the robotic system 206 without excessive bending).

The slide apparatus 246 includes the one or more rails 248 (also referred to herein as “slide rails”). The rail(s) 248 extend along a slide direction 412 of the cable holder components 244. The one or more rails 248 are supported by the base structure 402. The one or more rails 248 are mechanically coupled to the base structure 402 (e.g., via one or more vertical member 406) (e.g., via bolts, screws, one or more welds, or via other coupling or connection means).

The one or more cable holder components 244 are movably configured on the slide apparatus 246. For example, the slide apparatus 246 may include a sliding component 414 that is movably coupled to a given rail 248. The cable holder components 244 are connected or coupled with respective sliding components 414. The enables the cable holder components 244 to move or slide along the slide direction 412. The cable holder components 244 may be pivotably connected or coupled with respective sliding components 414. For example, a cable holder component 244 may be coupled to the slide apparatus 246 (e.g., to a sliding component 414) such that the cable holder component 244 to enabled to pivot about an axis 416. For example, the one or more cable holder components are pivotably coupled to respective slide rails 248 (e.g., via respective sliding components 414) and are movable along the one or more slide rails 248 via the sliding components 414.

For example, the cable holder components 244 are configured to move along the slide apparatus 246 (e.g., in the slide direction 412) as a movement of the robotic system 206 causes the one or more energy transfer cables 238 to move (e.g., due to the coupling between the energy transfer cables 238 and the robotic system 206). For example, as the slide system 210 moves the robotic system 206 to an external environment (e.g., outside of the housing 202), the energy transfer cable(s) 238 are pulled due to the movement of the robotic system 206. The force applied by the energy transfer cable(s) 238 causes respective cable holder components 244 to move via the slide apparatus 246 in the slide direction 412 (e.g., toward the portal 204). For example, the one or more cable holder components 244 are configured to move along the slide apparatus 246 as a movement of the robotic system 206 causes the one or more energy transfer cables 238 to move. This enables the cable holder components 244 to support a mass of the energy transfer cables 238 and to ensure that the energy transfer cables 238 are not bent beyond respective bend radii as the robotic system 206 moves.

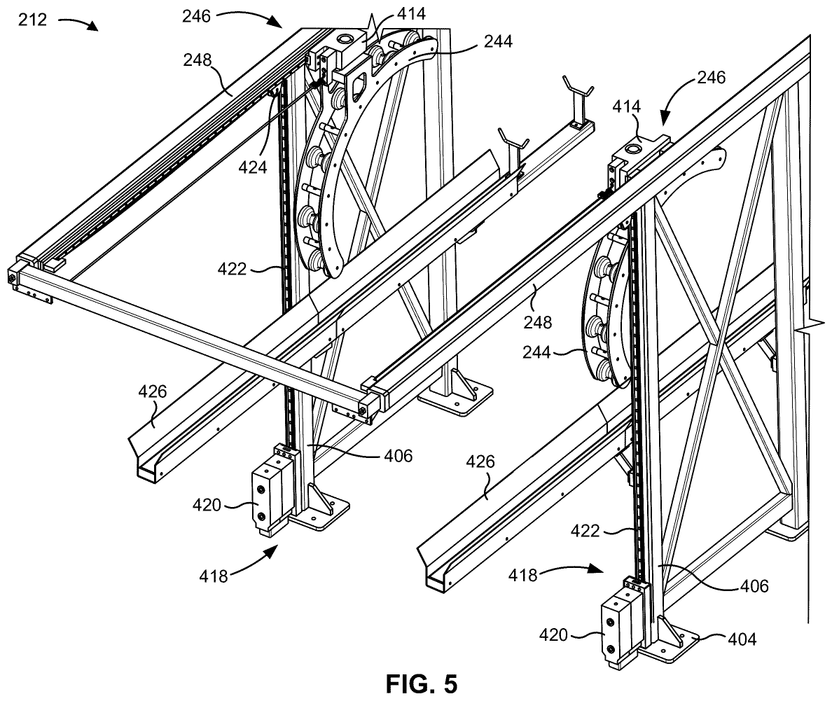

As the slide system 210 moves the robotic system 206 from external environment (e.g., outside of the housing 202) to the interior of the housing 202, a tensioning system 418 causes the cable holder components 244 to move along the slide apparatus 246 in the slide direction 412 (e.g., away from the portal 204). For example, the tensioning system 418 includes one or more counterweights 420 connected to respective cable holder components 244 via a cable 422. A cable holder component 244 and a cable 422 may be connected via a mechanical arrangement 424, such as a pulley system, among other examples. In other examples, other types of tensioning systems 418 may be utilized to maintain tension in the energy transfer cable(s) 238, such as one or more belts, one or more elastic cables, and/or one or more tensioning cables, among other examples. The tensioning system 418 is depicted and described in more detail in connection with FIG. 5.

The cable management system 212 includes one or more guide rails 426 for guiding the energy transfer cables 238 to respective cable holder components 244. The guide rails 426 are configured to guide the energy transfer cables 238 from the energy transfer outlet system 214 to respective cable holder components 244. For example, the guide rails 426 are configured to support a mass of respective the energy transfer cables 238 (e.g., so that the energy transfer cables 238 do not sag when exiting the energy transfer outlet system 214). The guide rails 426 have a trough configuration (e.g., a long, narrow container or structure with a concave or U-shaped cross-section). The guide rails 426 extend along the same plane and/or in the same direction as the one or more rails 248.

As indicated above, FIG. 4 is provided as an example. Other examples may differ from what is described in connection with FIG. 4.

FIG. 5 is a diagram of an example of a cable holder component 244 of the cable management system 212 described herein.

As described elsewhere herein, the tensioning system 418 is configured to keep tension on the energy transfer cables 238 as the one or more cable holder components 244 move along the one or more rails 248. The tensioning system 418 includes the one or more counterweights 420 (e.g., which may also be referred to as tensioning blocks or tensioning components) connected to respective cable holder components 244 via one or more pulley systems (such as the mechanical arrangement 424). In some examples, a mass of the one or more counterweights 420 is based on a tension level desired for the energy transfer cables 238. For example, the tension level in the energy transfer cables 238 can be configured or tuned by modifying the mass of the counterweights 420. For example, counterweights 420 with more mass may result in a higher tension level in the energy transfer cables 238.

In the example shown in FIG. 5, the tensioning system 418 is a counterweight-pulley system. For example, as a cable holder component 244 moves forward along the rail 248 (e.g., away from the mechanical arrangement 424), one or more counterweights 420 are pulled by the cable 422. This causes the one or more counterweights 420 to be pulled up along a vertical member 406 of the base structure 402 toward the rail 248. The mass of the one or more counterweights 420 results in tension in an energy transfer cable 238 because force is needed to move the cable holder component 244 plus the one or more counterweights 420. This force results in tension in the energy transfer cable 238 that is pulling the cable holder component 244 along the rail 248.

As the cable holder component 244 moves backward along the rail 248 (e.g., toward the mechanical arrangement 424), the mass of the one or more counterweights 420 pulls the cable holder component 244 along the rail 248 (e.g., as the counterweights move down the vertical member 406 toward the mounting plate 404). The pulling force from the mass of the one or more counterweights 420 improves the likelihood that tension is kept in the energy transfer cable 238 (e.g., as the robotic system 206 moves from an external environment into the interior of the housing 202). The tension in the energy transfer cable 238 reduces the likelihood of sagging or drooping in the energy transfer cable 238, thereby reducing the likelihood that the energy transfer cable 238 contacts or catches on another component of the energy transfer system 200 as the robotic system 206 moves from an external environment into the interior of the housing 202.

As indicated above, FIG. 5 is provided as an example. Other examples may differ from what is described in connection with FIG. 5.

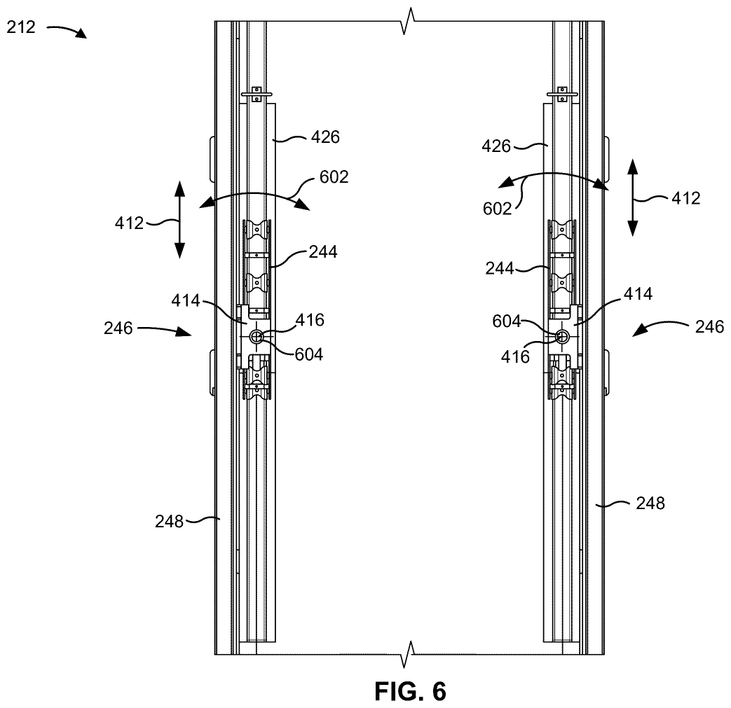

FIG. 6 is a diagram of an example of the cable management system 212 described herein. FIG. 6 shows a top view of the cable management system 212.

As described elsewhere herein, the cable holder components 244 are movable in the slide direction 412 via the slide apparatus 246 (e.g., along the length 252 of the housing 202). Additionally, the cable holder components 244 are pivotable along the axis 416 that is perpendicular to the slide direction 412. For example, the cable holder components 244 are pivotable along a pivot direction 602.

For example, a cable holder component 244 is pivotably mounted to the slide apparatus 246 to enable the cable holder component 244 to pivot about the axis 416 (e.g., that is orthogonal to the slide direction 412 in which the cable holder component 244 is configured to move along the slide apparatus 246). For example, the cable holder component 244 is coupled or connected to the sliding component 414. The sliding component 414 includes a rod 604. The rod 604 defines the axis 416. For example, the rod 604 is inserted into the sliding component 414. The rod 604 is configured to rotate within the sliding component 414. The cable holder component 244 is directly or indirectly coupled to the rod 604. As a result, the cable holder component 244 can pivot or rotate along the pivot direction 602 (e.g., as the rod 604 rotates). Enabling the cable holder component 244 to pivot provides additional movement flexibility to the energy transfer cables 238 (e.g., as the robotic system 206 and/or the end effector 208 move left-to-right, rather the forward-and-back into or out of the interior of the housing 202). The additional movement flexibility reduces the likelihood of the energy transfer cables 238 bending or kinking, thereby reducing the likelihood of damage to the energy transfer cables 238.

As indicated above, FIG. 6 is provided as an example. Other examples may differ from what is described in connection with FIG. 6.

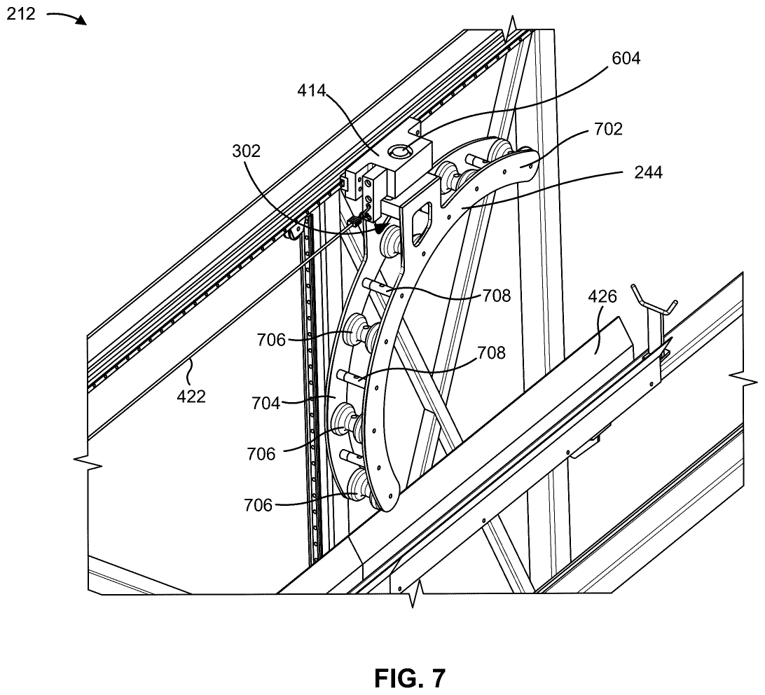

FIG. 7 is a diagram of an example of an cable holder component 244 of the cable management system 212 described herein.

The cable holder component 244 has a curved shape or curved configuration to prevent bending of the energy transfer cables 238 beyond the bend radius of the energy transfer cables 238. As shown in FIG. 7, the cable holder component 244 has a convex curvature defined by a radius. An energy transfer cable 238 may be routed over an outer convex curvature of the cable holder component 244 (e.g., through the opening 302) where the outer convex curvature has the radius. The curved shape includes a crescent shape. As used herein, “crescent” shape refers to a partial-circle shape. The radius is based on a permissible bend radius of the energy transfer cables 238. For example, the radius is greater than or equal to the permissible bend radius.

The cable holder component 244 includes a first plate 702 and a second plate 704. The first plate 702 and the second plate 704 define the curved shape of the cable holder component 244 (e.g., the first plate 702 and the second plate 704 have the curved shape described herein). The cable holder component 244 includes one or more roller components 706 configured between the first plate 702 and the second plate 704. The one or more roller components 706 extend between the first plate 702 and the second plate 704. The cable holder component 244 includes one or more structural members 708. The one or more structural members 708 are configured between the first plate 702 and the second plate 704 in a similar manner as the one or more roller components 706.

The roller components 706 has a circular cross section with larger diameters on the ends of the roller components 706 and a smaller diameter in the middle of the of the roller components 706. The configuration of the roller components 706 enables an energy transfer cable 238 to move or slide over the roller components 706 with reduced friction and/or with a reduced likelihood of catching on the cable holder component 244.

As indicated above, FIG. 7 is provided as an example. Other examples may differ from what is described in connection with FIG. 7.

### INDUSTRIAL APPLICABILITY

In some examples, energy transfer between an energy transfer dispenser system and a machine may be accomplished using one or more energy transfer cables. An energy transfer cable may be a medium for transferring energy between the energy transfer dispenser system and a receptacle on the machine. However, some energy transfer cables have a large size and limited flexibility. For example, energy transfer cables designed for high-energy transfers may be bulky and rigid, resulting in the energy transfer cables being difficult to maneuver and/or bend. Maneuvering the energy transfer cables in tight spaces and/or through complex setups or systems is cumbersome and presents logistical and/or system design challenges. This increases the risk of damage to the energy transfer cables caused by bending the energy transfer cables to a radius that is less than a bend radius of the energy transfer cables. Additionally, system for energy transfer may have many components and/or moving parts. This increases the risk of damage to the energy transfer cables, the components, and/or moving parts caused by the energy transfer cables contacting, rubbing, moving, and/or otherwise engaging with the components and/or moving parts as the system operates. Further, because of the large size and limited flexibility of the energy transfer cables, it is difficult to maintain a desired tension level in the energy transfer cables as the system operates. Failing to maintain the desired tension level may result in slack in the energy transfer cables (e.g., increasing the risk of the energy transfer cables contacting or being caught on other components of the system) and/or resulting in excessive tension in the energy transfer cables (e.g., increasing the risk of damage to the energy transfer cables caused by the excessive tension).

The energy transfer system and/or the cable management system described herein enables a mechanism for management of the energy transfer cables extending from an energy transfer dispenser system to a robotic system of the energy transfer system. The cable management system is configured within the interior of the housing of the energy transfer system. The cable management system includes one or more cable holder components movably configured on a slide apparatus, enabling the one or more cable holder components to move or slide along the slide apparatus. The cable holder components are also pivotably connected to the slide apparatus. The one or more energy transfer cables are configured to be routed through respective cable holder components of the one or more cable holder components (e.g., to an end effector of the robotic system). The cable holder components have a convex curvature defined by a radius.

The cable holder component may move (e.g., slide) along the slide apparatus (e.g., via a rail) as the robotic system (e.g., via the slide system) and/or the end effector move. The reduces the complexity associated with routing the energy transfer cable for the energy transfer system, reduces the length of the energy transfer cable, and/or reduces the likelihood of damage to the energy transfer cable that may otherwise be caused by the energy transfer cable being bent at a radius that is less than a bend radius of the energy transfer cable, among other examples. For example, the cable holder component has a curved shape or configuration defined by the radius. The radius of the cable holder component is based on the bend radius of the energy transfer cable. For example, the radius is greater than or equal to the bend radius of the energy transfer cable. This reduces the likelihood that the energy transfer cable is bent at a radius that is less than the bend radius (e.g., reducing the likelihood of damage to the energy transfer cable that would otherwise be caused by the energy transfer cable being bent at a radius that is less than the bend radius).

The cable management system includes a tensioning system configured to maintain tension in the energy transfer cables as the robotic system and/or cable holder components move. Maintaining tension in the energy transfer cables reduces the likelihood of sagging or drooping in the energy transfer cables, thereby reducing the likelihood that the energy transfer cable contacts or catches on another component of the energy transfer system as the robotic system moves between an external environment into the interior of the housing.

Additionally, by the cable holder components being pivotably attached to the slide apparatus, the cable holder components can pivot or rotate along a pivot direction. Enabling the cable holder components to pivot provides additional movement flexibility to the energy transfer cables (e.g., as the robotic system and/or the end effector move left-to-right, rather the forward-and-back into or out of the interior of the housing). The additional movement flexibility reduces the likelihood of the energy transfer cables bending or kinking, thereby reducing the likelihood of damage to the energy transfer cables.

What is claimed is:

1. An energy transfer system, comprising:
a housing;
a robotic system movable between an interior of the housing and an external environment;
one or more energy transfer cables coupled to the robotic system for enabling energy transfer; and
a cable management system configured within the interior of the housing, the cable management system comprising one or more cable holder components movably configured on a slide apparatus, and the one or more energy transfer cables are configured to be routed through respective cable holder components of the one or more cable holder components.

2. The energy transfer system of claim 1, wherein each of the one or more cable holder components has a curved configuration defined by a radius, and
wherein the radius is based on a permissible bend radius of the one or more energy transfer cables.

3. The energy transfer system of claim 1, wherein the housing includes a portal through which the robotic system is movable between the interior of the housing and the external environment,
wherein the portal is included in a front side of the housing, and
wherein the slide apparatus enables the one or more cable holder components to move along a plane that is perpendicular to the front side of the housing.

4. The energy transfer system of claim 1, wherein the cable management system further comprises:
a tensioning system for maintaining a tension level for the one or more energy transfer cables as the robotic system moves.

5. The energy transfer system of claim 4, wherein the tensioning system includes one or more tensioning blocks connected to respective cable holder components of the one or more cable holder components via one or more pulley systems.

6. The energy transfer system of claim 5, wherein a mass of the one or more tensioning blocks is based on the tension level.

7. The energy transfer system of claim 1, wherein the one or more cable holder components are movable in a direction via the slide apparatus, and
wherein the one or more cable holder components are pivotable along an axis that is perpendicular to the direction.

8. A cable management system for energy transfer cables, comprising:
a base structure;
one or more slide rails mechanically coupled to the base structure; and
one or more cable holder components pivotably coupled to respective slide rails of the one or more slide rails, the one or more cable holder components being movable along the one or more slide rails, and the one or more cable holder components having a curved shape to prevent bending of the energy transfer cables beyond a bend radius of the energy transfer cables.

9. The cable management system of claim 8, wherein each cable holder component, of the one or more cable holder components, includes:
a first plate and a second plate defining the curved shape, and
one or more roller components configured between the first plate and the second plate.

10. The cable management system of claim 8, further comprising:
one or more guide rails for guiding the energy transfer cables to respective cable holder components of the one or more cable holder components.

11. The cable management system of claim 8, further comprising:
a tensioning system configured to keep tension on the energy transfer cables as the one or more cable holder components move along the one or more slide rails.

12. The cable management system of claim 11, wherein the tensioning system includes counterweights connected to respective cable holder components of the one or more cable holder components.

13. The cable management system of claim 8, wherein the curved shape includes a crescent shape.

14. The cable management system of claim 8, wherein the curved shape is defined by a radius, and wherein the radius is greater than or equal to the bend radius.

15. A system, comprising:
a housing;
a robotic system movable between an interior of the housing and an external environment;
one or more energy transfer cables coupled to the robotic system for enabling energy transfer; and
a cable management system configured within the interior of the housing, the cable management system comprising:
a base structure;
a slide apparatus supported by the base structure; and
one or more cable holder components movably configured on the slide apparatus,
wherein the one or more energy transfer cables are routed to the robotic system through respective cable holder components of the one or more cable holder components.

16. The system of claim 15, wherein the slide apparatus includes one or more rails extending along a length of the housing.

17. The system of claim 15, wherein the one or more cable holder components are configured to move along the slide apparatus as a movement of the robotic system causes the one or more energy transfer cables to move.

18. The system of claim 15, wherein the slide apparatus is configured on the base structure at a height that is based on a connection point at which the one or more energy transfer cables are connected to the robotic system.

19. The system of claim 15, wherein the cable management system further comprising:
a tensioning system that includes one or more tensioning components coupled to respective cable holder components of the one or more cable holder components,
wherein the one or more tensioning components are configured to keep tension on the one or more energy transfer cables as the robotic system moves.

20. The system of claim 15, wherein the one or more cable holder components are pivotably mounted to the slide apparatus to enable the one or more cable holder components to pivot about an axis that is orthogonal to a slide direction in which the one or more cable holder components are configured to move along the slide apparatus.
